(19) United States
(12) Patent Application Publication
(10) Pub. No.: US 2012/0055062 A1
(43) Pub. Date: Mar. 8, 2012

(54) MOUNTING BRACKETS FOR CONNECTING TUBULAR BODIES

(76) Inventors: Sergei Y. Mironichev, Moscow (RU); Christopher D. Mechling, San Diego, CA (US)

(21) Appl. No.: 13/009,578

(22) Filed: Jan. 19, 2011

Related U.S. Application Data
(60) Provisional application No. 61/296,251, filed on Jan. 19, 2010.

(51) Int. Cl. F41C 23/02; F16M 13/02

(52) U.S. Cl. 42/85; 248/224.8; 248/222.14; 248/222.11

(57) ABSTRACT

Devices for connecting tubular bodies, such as rifle scopes and flashlights, to armament are disclosed herein. In a first preferred embodiment, the device has a screw and spring combination that is quickly detachable and is adjustable along scope axis. In a second preferred embodiment, the device has a riser portion that extends the cylindrical body out according to desires of a user. In yet another preferred embodiment, the device is modified to engage a sling swivel hole typically provided for a rifle shoulder strap. All embodiments further comprise aluminum alloy with black anodized coating.

### PRIORITY CLAIM

This patent application contains subject matter claiming benefit of the priority date of U.S. Provisional Patent Application Ser. No. 61/296,251 filed on Jan. 19, 2010 and entitled MOUNTING BRACKETS FOR CONNECTING TUBULAR BODIES, accordingly, the entire contents of this provisional patent application is hereby expressly incorporated by reference.

### BACKGROUND OF THE INVENTION

1. Field of the Invention

The present invention pertains generally to devices useful to connecting parallel cylindrical bodies. More particularly, the present invention relates to weaponry wherein a user desires to attach accessories thereto, such as tactical lights, rifle scopes, and laser sights. In a preferred embodiment, the present invention is useful as a mounting bracket for coupling said accessories to a barrel of a firearm.

2. Description of the Prior Art

A continuing desire to achieve tactical advantage in military and law enforcement operations has lead to the attachment of accessories to firearms like rifles and assault rifles. An example of such accessories is a tactical light to aid a user in low light target identification. A primary benefit of this configuration is that a marksman can simultaneously aim and illuminate a target. Another obvious benefit is that the user will not have to hold the illumination device. Initially, the tactical advantage calls for the flashlight to be light weight while maintaining high intensity characteristics. Next the flashlight or accessory should be properly mounted to the weapon.

Typically in the industry, weapons are now manufactured with a fixed platform useable to mount accessories such as a Picatinny rail or Weaver rail. These rail systems employ a series of parallel rails or grooves aligned perpendicular to a longitudinal axis. Since rifle scopes and other accessories come in various shapes and sizes, there have emerged several types of mounting brackets for attachment thereto. The present invention aims to provide a mounting solutions particular useful for relatively small elongated tubular bodies such as those of tactical flashlights but also to slightly larger cylindrical bodies.

In light of the above, it is an object of the present invention to provide a firearm mounting device adaptable to the standardized Picatinny and Weaver rail systems. It is an additional object of the present invention to provide a mounting bracket that will secure an accessory to a firearm in a fixed and rigid manner. It is further an object of the present invention to provide a mounting bracket that is quickly detachable and resistant to corrosion and extreme conditions. Additionally, it is an object of the present invention to provide a design that is adjustable along scope (longitudinal) axis. It is still further an object of the present invention to provide a mounting device that is attachable to an underside of a rifle barrel. An additional object of the present invention is to provide a mounting bracket that can provide adjustment in the vertical plane.

### BRIEF SUMMARY OF THE INVENTION

The present invention specifically addresses and alleviates the above mentioned deficiencies associated with the prior art. More particularly, the present invention, in a first aspect is a quickly detachable mounting bracket for connecting tubular bodies comprising: a first half ring portion for engaging a first tubular body; a second half ring portion coupled to the first half ring portion for engaging the first tubular body the second half ring portion having a raised orifice on an upper portion thereof; a collar portion for engaging a second tubular body; and a pin between the collar portion and the second half ring portion for detachably engaging the raised orifice.

In invention in this aspect is additionally characterized wherein the pin is threaded and is received by complementary threads of the raised orifice. Additionally, the invention has a circular member coupled to the collar portion, together with the pin for detachably engaging the second half ring portion, the circular member having openings to access an interior thereof, the pin having a flanged end on a distal end thereof, the flanged end for rotating the pin for detaching the collar portion from the second half ring portion.

Further, the invention in a first aspect includes a spring surrounding the pin and within the circular member for providing a secure connection between the collar portion and the second half ring portion via the circular member. Also the invention in this embodiment is further characterized wherein the collar portion has three reliefs carved out thereof with the remaining bars resembling a squirrel cage. Yet still further the quickly detachable mounting bracket for connecting tubular bodies further comprises a black anodized coating at an exterior thereof.

The present invention in a second aspect may be characterized as a mounting bracket for connecting tubular bodies comprising: a first half ring portion; a combination half ring portion and riser portion having a predetermined height, the combination half ring portion and riser portion being an integral unit and having a first notched half portion at an end thereof; a second notched half portion releasably connected to the combination half ring portion and riser portion opposite the first notched half portion, the first notched half portion together with the second notched half portion configured to engage a rail of a firearm, and wherein the first half ring portion together with the combination half ring portion and riser portion are configured to engage a tubular body.

The mounting bracket for connecting tubular bodies in this aspect additionally includes a first flanged end to the first half ring portion; and a second flanged end to the combination half ring portion and riser portion to complement the first flanged end for engaging the tubular body. Further in the preferred embodiment, the combination half ring portion and riser portion has a hollowed out body. Also, optionally a collar is configured to fit inside of the first half ring portion and the combination half ring portion and riser portion to stabilize and securely engage said tubular body.

The invention in a second aspect is additionally characterized wherein the combination half ring portion and riser portion comprises a first riser portion and a second riser portion, the first and second riser portions each having a hollowed out body, and wherein the second riser portion hollowed out body tapers to the first riser portion hollowed out body.

In a still a third aspect, the present invention is characterized as a sling swivel mount for configuring a rail mounting system to an underside of a gun barrel comprising: a first substrate forming an underside of the rail system; an aperture in the first substrate to receive a sling swivel hole; and a pin for engaging though the sling swivel hole when the sling swivel hole is brought down through the aperture.

The sling swivel mount herein for configuring a rail mounting system to an underside of a gun barrel additionally comprises a second and a third substrate on opposing sides of the aperture, the second and third substrate both fixed on one end to the first substrate and both engaging the underside of the gun barrel on an opposite end providing stabilization to the sling swivel mount. Lastly, the sling swivel mount is characterized wherein the third substrate other end is secured to the underside of the gun barrel via an adjustment screw.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective illustration of a first preferred quickly detachable mounting bracket;

FIG. 1B is a perspective view of an exemplary intended use of the quickly detachable mounting bracket of FIG. 1A;

FIG. 1C illustrates a first exploded view thereof;

FIG. 1D is an additional perspective view of the first preferred embodiment ring and collar portions;

FIG. 1E is a cross sectional illustration of the first preferred device taken along line 1E-1E in FIG. 1B;

FIG. 2A is a perspective illustration of another preferred mounting bracket of the present invention;

FIG. 2B is a profile view of the invention embodiment illustrated in FIG. 2B;

FIG. 3A illustrates a profile view a sling swivel mount embodiment of the present invention configured to a forward sling swivel hole of a rifle;

FIG. 3B is an enlarged view thereof;

FIG. 3C is a perspective view of a sling swivel mount coupled to a flashlight via the mounting bracket embodiment illustrated in FIG. 2A;

FIG. 3D is a cross sectional illustration of the first preferred device taken along line 3D-3D in FIG. 3C;

FIG. 3E is a similar profile illustration; and

FIG. 3F is a top plan view thereof;

### DETAILED DESCRIPTION OF PREFERRED EMBODIMENTS

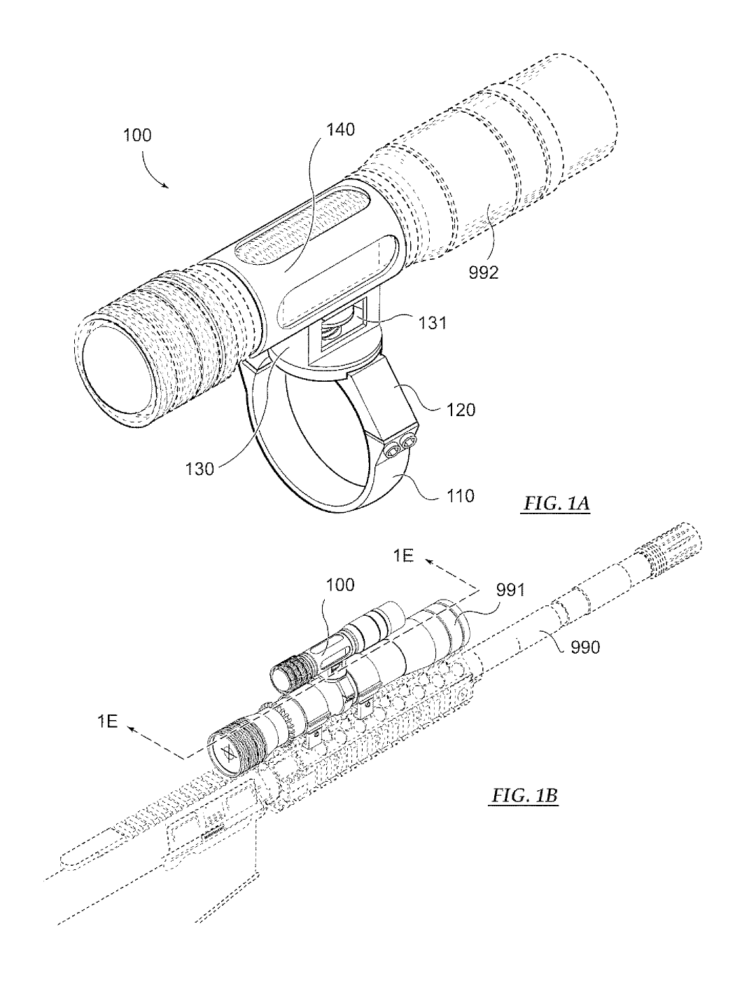

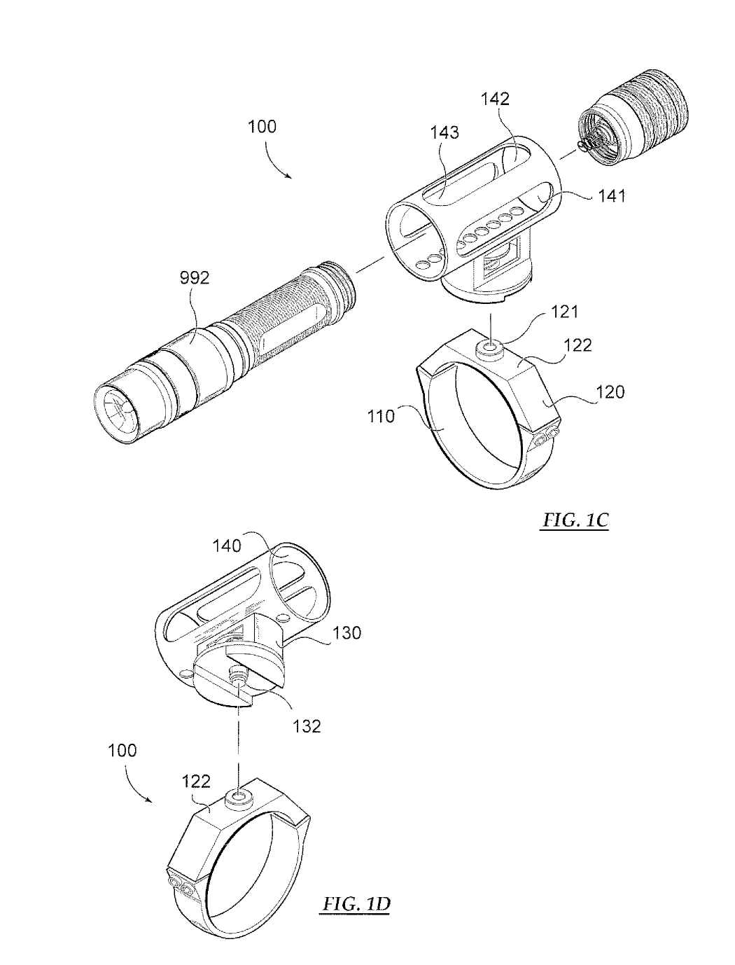

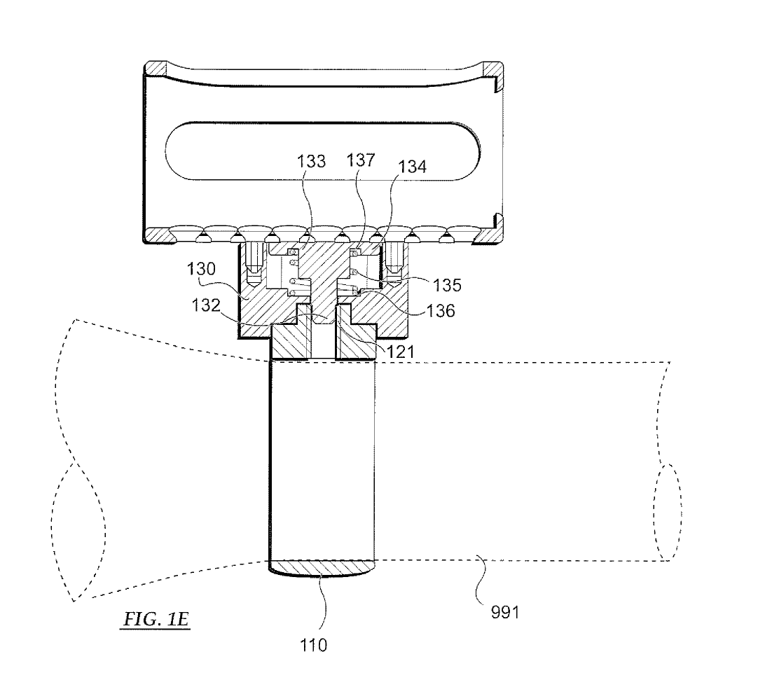

With reference to FIG. 1A, a perspective illustration of a first preferred mounting bracket 100 embodiment coupled to a tactical flashlight 992 is shown. Generally, the device 100 comprises a ring portion 120 coupled to a collar portion 140 having a circular member 130 therebetween (also as seen in FIG. 1C and FIG. 1D). Additionally, the ring 120 and collar 140 portions are easily detachable as further detailed herein.

With regard to FIG. 1B, an exemplary intended use of the first preferred embodiment 100 is illustrated. Therein, a tactical light 992 is detachably connected to a rifle scope 991, the rifle scope 991 itself attached to a fixed rail mounting system. FIG. 1C illustrates a first exploded view this particular invention embodiment 100. In this rendition 100, the tactical light 992 has a tubular body flanked by its head lamp portion and its 992 end cap. As shown, the end cap may be easily removed to slide the collar portion 140 of the present invention 100 over the tubular body. Also as can be seen, the collar portion 140 has three reliefs 141, 142, 143 carved out thereof; and in this way, the collar portion 140 resembles a squirrel cage. As shown, the collar portion has three reliefs 141, 142, 143 carved out thereof.

Further with regard to FIG. 1C and additionally FIG. 1D, the quickly detachable mounting bracket 100 for connecting tubular bodies 991, 992 has a first half ring portion 110 for engaging a first tubular body 992. A second half ring portion 120 is coupled to the first half ring portion 110 for engaging the first tubular body 992; and the second half ring portion 120 has a raised orifice 121 on an upper portion 122 thereof 120. The raised orifice 121 is provided for engaging a pin 132 of the present invention (FIG. 1E). A pin 132 could alternatively be a screw or plunger 132 or the like. Circular member 130 is provided with openings 131 to access pin 132 further providing quick detachability as further detailed herein.

Now turning to FIG. 1E, a cross sectional illustration is provided taken along line 1E-1E in FIG. 1B. As stated, circular member 130 couples collar portion 140 to ring portion 110 when pin 132 is engaged. In a preferred embodiment, pin 132 is threaded and is received by complementary threads of the raised orifice 121. The pin 132 further has a flanged end 134 on a distal end thereof 132, the flanged end 134 for rotating the pin 132 for detaching the collar portion 140 from the second half ring portion 110. Spring 135 surrounds the pin 132 within the circular member 130 for providing a secure connection between the collar portion 140 and the second half ring portion 120. More specifically, pin 132 has a mid-portion 133 that is wider than the portion of the pin 132 that engages the raised orifice 121 for complementing the spring 135. Further to the spring 135, reliefs 136, 137 are provided as an abutment 136, 137 to the spring 135. The first relief 136 is in the circular member 130 and the second relief 137 is in the flanged end 134 of pin 132, as shown.

Further to the connection of circular member 130 to second half ring portion 120, an underside of the circular ring portion has a U-channel configuration to better receive the upper portion 122 of second half ring portion 120. This feature further provides easy detachment in the event that an accessory is desired to be changed, or if the flashlight 992 is desired to be employed by a user separate from any weapon 990.

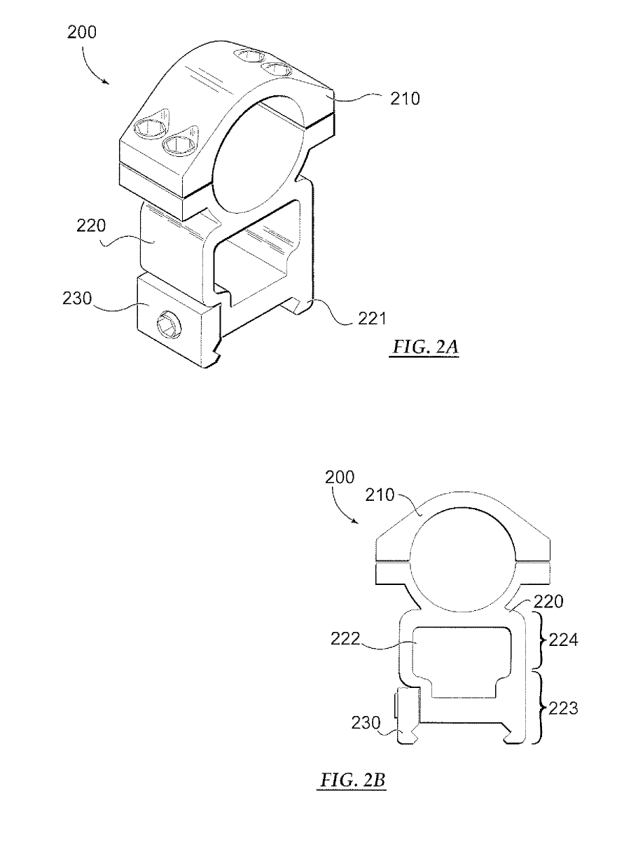

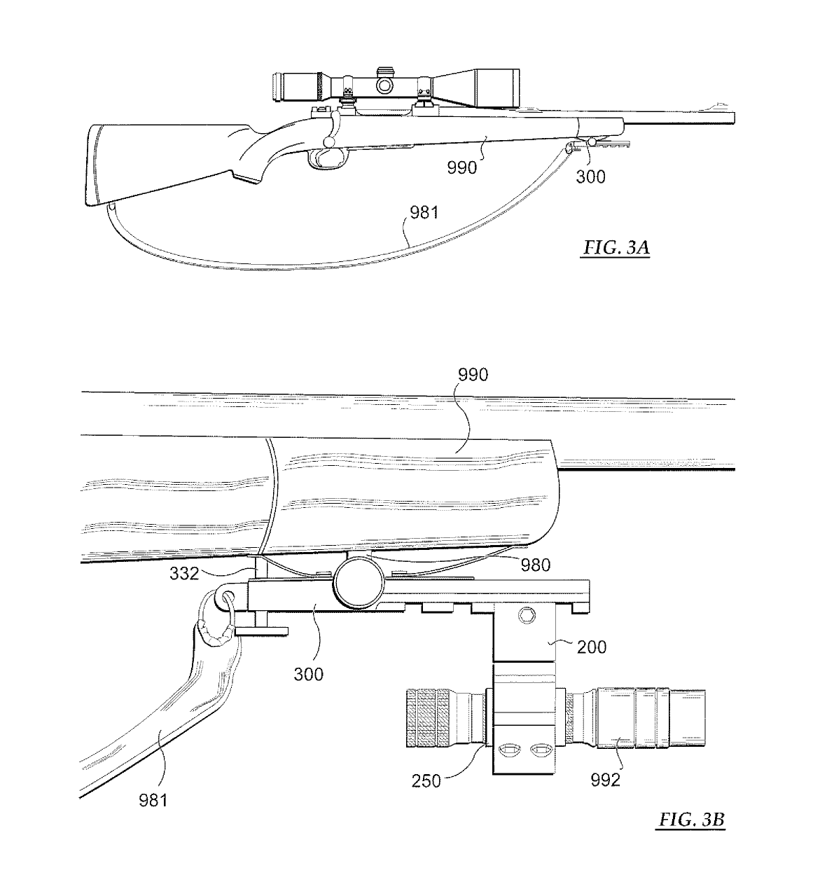

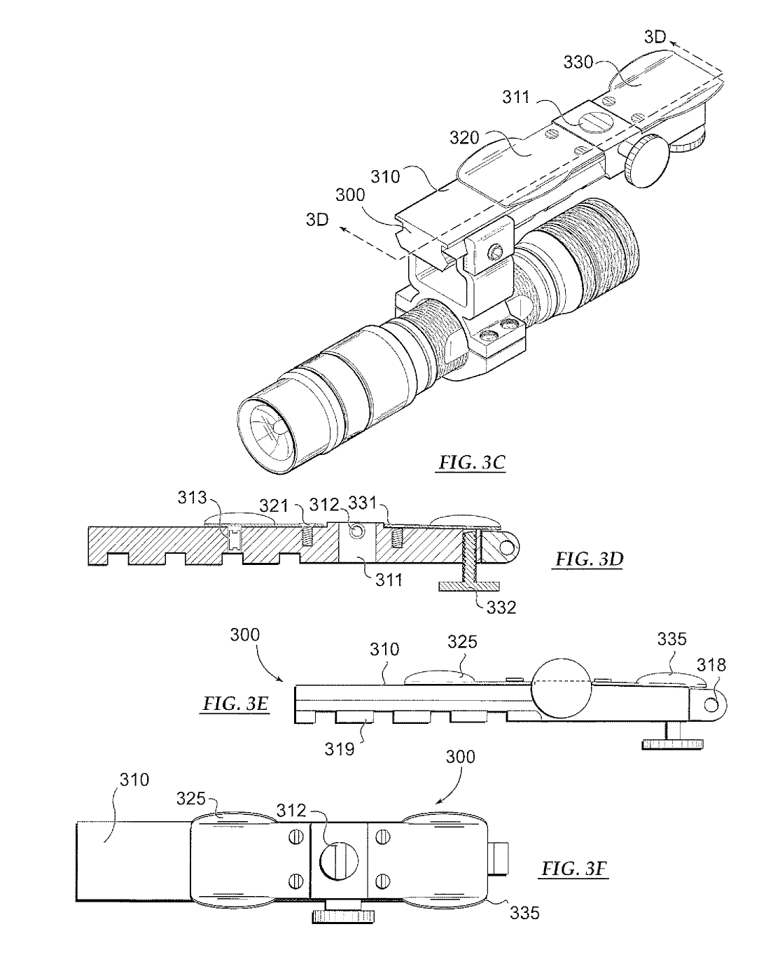

FIG. 2A and FIG. 2B introduce another mounting bracket embodiment 200 of the present invention. In this example 200, a first half ring portion 210 coupled with a combination half ring portion and riser portion 220 will be secured to a tactical flashlight 992 (see e.g. FIG. 3B) instead of a more elongated collar 140. The ring portions 210, 220 herein 200 contain two semi-circular halves with flanged ends. Theses flanges may be secured and tightened with screws as shown. Further, a sleeve 250 is optionally configured inside of the ring portion 210, 220, as is shown in FIG. 3B. The second half ring portion 220 additionally extends to a riser portion 220, 223, 224 that gives the device a desired height. More specifically, the device has a first riser portion 223 and a second riser portion 224 providing the desired height. A hollowed out interior 220 further tapers from the second riser portion 224 to the first riser portion 223 providing height 223, 224. The tapering 222 further allow the device to have a substantially constant width as shown. In preferred embodiments, the height 223, 224 is selectable to 2.5 mm, 5.0 mm and 10 mm in height.

Further to this embodiment 200, the combination half ring portion and riser portion 220 is an integral unit and also has a first notched half portion 221 at an end thereof 220; and a second notched half portion 230 is provided releasably connected to the combination half ring portion and riser portion 220 opposite the first notched half portion 220. The first notched half portion 221 together with the second notched half portion 231 are configured to engage a rail of a firearm (or a sling swivel rail system 300, FIG. 3B). Optionally, a collar/sleeve 250 is configured inside ring portions 210, 220 as illustrated in FIG. 3B.

With regard to FIG. 3A and FIG. 3B, an additional embodiment 300 of the present invention 100, 200, 300 is illustrated in profile views. This mounting bracket 300 of the present invention configured to a novel sling swivel rail 319 to mount accessories thereto 300. More specifically, the rail provided 300, 319 connects to an underside of a gun 990 barrel where a sling swivel hole 980 typically is located for connection to a shoulder strap 981.

FIG. 3C through FIG. 3F show various views of this embodiment 300. As best seen in FIG. 3C and FIG. 3E, the rail 319 is mounted on a substrate first layer 310 wherein a pair of second layers 320, 330 provide vertical adjustment and stabilization to a tactical flashlight 992 as shown in FIG. 3B. The second and third layers 320, 330 are fastened 321, 331 only on one end as shown and the adjustment screw provides adjustment 332 in the vertical plane. Additionally, adjustment screw 332 secures the device to the underside of the gun barrel. Similarly, screw 313 is provided for the same purpose.

Also according to FIG. 3C through FIG. 3F, wings 325, 335 are optionally provided to facilitate the mating of the device 300 to the underside of the gun 990 barrel. The wings 325, 335 could however be omitted within the scope of the present preferred embodiment 300.

The sling swivel mount 300 for configuring a rail mounting system 319 to an underside of a gun barrel 990 further has an aperture 311 in the first substrate 310 to receive a sling swivel hole 980. Also a pin 312 for engaging though the sling swivel 980 hole when the sling swivel hole 980 is brought down through the aperture 311.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Mounting Brackets for Connecting Tubular Bodies as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A quickly detachable mounting bracket for connecting tubular bodies comprising:
a first half ring portion for engaging a first tubular body;
a second half ring portion coupled to the first half ring portion for engaging the first tubular body the second half ring portion having a raised orifice on an upper portion thereof;
a collar portion for engaging a second tubular body; and
a pin between the collar portion and the second half ring portion for detachably engaging the raised orifice.

2. The quickly detachable mounting bracket for connecting tubular bodies of claim 1 wherein the pin is threaded and is received by complementary threads of the raised orifice.

3. The quickly detachable mounting bracket for connecting tubular bodies of claim 1 further comprising a circular member coupled to the collar portion, together with the pin for detachably engaging the second half ring portion, the circular member having openings to access an interior thereof, the pin having a flanged end on a distal end thereof, the flanged end for rotating the pin for detaching the collar portion from the second half ring portion.

4. The quickly detachable mounting bracket for connecting tubular bodies of claim 3, further comprising a spring surrounding the pin and within the circular member for providing a secure connection between the collar portion and the second half ring portion via the circular member.

5. The quickly detachable mounting bracket for connecting tubular bodies of claim 1 wherein the collar portion has three reliefs carved out thereof with the remaining bars resembling a squirrel cage.

6. The quickly detachable mounting bracket for connecting tubular bodies of claim 1 further comprising a black anodized coating at an exterior thereof.

7. A mounting bracket for connecting tubular bodies comprising:
a first half ring portion;
a combination half ring portion and riser portion having a predetermined height, the combination half ring portion and riser portion being an integral unit and having a first notched half portion at an end thereof;
a second notched half portion releasably connected to the combination half ring portion and riser portion opposite the first notched half portion, the first notched half portion together with the second notched half portion configured to engage a rail of a firearm, and wherein the first half ring portion together with the combination half ring portion and riser portion are configured to engage a tubular body.

8. The mounting bracket for connecting tubular bodies of claim 7 further comprising:
a first flanged end to the first half ring portion; and
a second flanged end to the combination half ring portion and riser portion to complement the first flanged end for engaging the tubular body.

9. The mounting bracket for connecting tubular bodies of claim 7 wherein the combination half ring portion and riser portion has a hollowed out body.

10. The mounting bracket for connecting tubular bodies of claim 7 further comprising a collar configured to fit inside of the first half ring portion and the combination half ring portion and riser portion to stabilize and securely engage said tubular body.

11. The mounting bracket for connecting tubular bodies of claim 7, wherein the combination half ring portion and riser portion comprises a first riser portion and a second riser portion, the first and second riser portions each having a hollowed out body, and wherein the second riser portion hollowed out body tapers to the first riser portion hollowed out body.

12. A sling swivel mount for configuring a rail mounting system to an underside of a gun barrel comprising:
a first substrate forming an underside of the rail system;
an aperture in the first substrate to receive a sling swivel hole; and
a pin for engaging though the sling swivel hole when the sling swivel hole is brought down through the aperture.

13. The sling swivel mount for configuring a rail mounting system to an underside of a gun barrel of claim 11, further comprising:
a second and a third substrate on opposing sides of the aperture, the second and third substrate both fixed on one end to the first substrate and both engaging the underside of the gun barrel on an opposite end providing stabilization to the sling swivel mount.

14. The sling swivel mount for configuring a rail mounting system to an underside of a gun barrel of claim 13, wherein the third substrate other end is secured to the underside of the gun barrel via an adjustment screw.
